(19) United States
(12) Patent Application Publication
(10) Pub. No.: US 2025/0255290 A1
(43) Pub. Date: Aug. 14, 2025

(54) COMPOSITION AND METHOD FOR ATTRACTING AND CATCHING KISSING BUGS

(71) Applicants: BanfieldBio, Inc., Woodinville, WA (US); Texas A & M University System, College Station, TX (US)

(72) Inventors: Gabriel L. Hamer, College Station, TX (US); Michael G. Banfield, Woodinville, WA (US); John H. Borden, Burnaby (CA)

(73) Assignees: BanfieldBio, Inc., Woodinville, WA (US); Texas A & M University System, College Station, TX (US)

(21) Appl. No.: 19/053,311

(22) Filed: Feb. 13, 2025

Related U.S. Application Data
(60) Provisional application No. 63/552,907, filed on Feb. 13, 2024.

(51) Int. Cl. A01M 1/04; A01M 1/10

(52) U.S. Cl. CPC A01M 1/04; A01M 1/106

(57) ABSTRACT

A novel composition comprising a multiple-funnel trap, a light source, a solar panel, a battery, a photoswitch to control the light source, and a supporting structure can be effectively used to capture night-flying adult kissing bugs (Hemiptera: Reduviidae).

### PRIORITY CLAIM

This application claims priority to and/or the benefit of U.S. provisional patent application Ser. No. 63/552,907 filed Feb. 13, 2024. The foregoing application is incorporated by reference in their entirety as if fully set forth herein.

### FIELD OF THE INVENTION

This invention pertains to a novel composition and related method of catching kissing bugs (Hemiptera: Reduviidae) that vector Trypanosoma cruzi, the causal agent of Chagas disease.

### BACKGROUND OF THE INVENTION

The Government will have a nonexclusive, nontransferable, irrevocable, paid-up license to practice, or have practiced for or on its behalf, the subject invention throughout the world.

Kissing bugs (Hemiptera: Reduviidae), also called triatomines, are the vectors of Trypanosoma cruzi, the parasite that causes Chagas disease among an estimated eight million humans, and also dogs, in the United States and Latin America (Lee et al. 2013; Hodo and Hamer 2017; de Lana and de Menezes Machado 2017). During adult dispersal (Lazzari et al. 2013) kissing bugs can spill-over from their sylvatic environment, where T. cruzi is maintained in wild animals, into the domestic and peridomestic environment where humans and domestic animals become at risk of exposure to T. cruzi. Adult dispersal behavior is the principal means of re-colonization of dwellings following insecticidal treatment to control kissing bugs (Vazquez-Prokopec et al. 2005). A recent survey of over 1,980 kissing bugs from Texas indicated a 65% T. cruzi infection rate in the insects found in or around human dwellings (Curtis-Robles et al. 2015). A study conducted between 2012-2015 (unpublished data from U.S. Army Public Health Command Central-C. Daniels) found that 52% of 224 kissing bugs collected at the Medina Annex-Lackland Air Force Base, Joint Base San Antonio in Texas were T. cruzi-positive. In bugs with discernable bloodmeals, human blood was the most common, comprising 30% of 117 bugs; 63% of those tested positive for T. cruzi. Dogs may be at even greater risk of exposure to kissing bugs and Chagas disease than humans, because they play, work and often sleep outdoors or are kept in kennels, in which there is a high risk of T. cruzi infection (Curtis-Robles et al. 2017). In addition, dogs are likely to consume kissing bugs, which is an efficient route of oral exposure to T. cruzi (Hodo and Hamer 2017).

Effective surveillance of kissing bug populations is needed to define habitats frequented by the bugs, to determine variation in T. cruzi infection, and to quantify temporal phenology of adult dispersal, all of which is a necessary basis for control programs (McPhatter et al. 2012). Trapping of flying insects in stand-alone unattended traps as a surveillance or population method demands that two criteria be met: 1) availability of a suitable trap and 2) some method of attracting adults of the target species to that trap. Trapping can be effective, accurate and inexpensive. For mosquitoes, the science and art are well developed. Several types of mosquito traps are commercially available and have been scientifically proven to be effective. These include the CDC Light Trap (Takken and Kline 1989), the EVS Trap (Irish et al. 2008), the Fay-Prince Trap (Schmaedick et al. 2008), the Mosquito Magnet Trap (Hoel et al. 2009), the BG Sentinel Trap (Maciel-de Freitas et al. 2006), and the Autocidal Gravid Ovitrap (Mackay et al. 2013). Much research has been done on potential lures to be used in traps for mosquitoes, but in practice the most common is CO2 produced from dry ice or a biotic engine employing a carbohydrate substrate and yeast (Oli et al. 2005; Mweresa et al. 2014). Other lures for mosquitoes include (but are not limited to): fatty acids that mimic the odor of unwashed feet (Knols et al. 1997a,b), L-(+)-lactic acid (Acree et al. 1968), 1-octen-3-ol (Takken and Kline 1989), ammonia (Braks et al. 2001; Mathew et al. 2013), 3-methyl-1-butanol (Mukabana et al. 2012), acetophenone (von Oppen et al. 2015), and 4-methylphenol (Bentley et al. 1979). Light may also be used as an attractant as embodied in the CDC Light Trap and the EVS Trap.

Background research has yielded results that could possibly be used to develop effective traps for flying kissing bugs. During the dispersal phase, flying kissing bugs are attracted to artificial lighting such as exterior street or home lights (Castro et al. 2010, Pacheco-Tucuch et al. 2012). Kissing bugs are attracted to numerous wavelengths of the visible and infrared light spectrum (Indacochea et al. 2017) although the full spectrum has not been evaluated for most species, including those most abundant in the USA. Considerable research has been done on behavior elicited by reduviid glandular extracts, but very little definitive research has been done on pheromone identification (Cruz-Lopez et al. 2001, Lazzari et al. 2013). One consistent observation is that fecal volatiles are attractive to flightless nymphs (Falvo et al. 2016) and adults. Another observation is that alarm pheromone components are consistently produced in Brindley's gland and that sex pheromone components are found in the metasternal gland (Lazzari et al. 2013). Surprisingly, isobutyric acid, the most prevalent “alarm” pheromone component in multiple species, is innately repellent to Triatoma infestans nymphs, but becomes attractive after prolonged exposure (Minoli et al. 2013). Recently, Bohman et al. (2018) demonstrated that a 10-component blend isolated from female Rhodnius prolixus metasternal glands is moderately attractive to adult males in a two-choice laboratory olfactometer.

Despite this background research, development of traps and lures for flying kissing bugs has not met success comparative to that with mosquitoes. Kissing bug populations are characteristically low compared to mosquitoes, suggesting that in addition to surveillance trapping, mass trapping could be effective in reducing populations if it were proven to be feasible (Sjogren and Ryckman 1966). However, no product or homemade trap combines convenient and inexpensive use with consistent efficacy, and in most experimental studies catches have ranged from low to zero. There are two exceptions. Sjogren and Ryckman (1966) captured 398 kissing bugs over a 5-month period (an average of 0.87 bugs per trap night) in three homemade panel traps constructed of upright 1.0×1.3 m white-painted tempered Masonite sheets baited with two 27-cm-long fluorescent tubes emitting ultraviolet light, with a collecting trough below. Updyke and Allan (2018) captured 0.4 kissing bugs per trap-night in experimental cross-vane traps fitted with an attractive light source.

Curtis-Robles et al. (2018) tested two types of mosquito traps for catching flying kissing bugs in Texas. The first was a Universal Mercury Vapor Black Light Trap (Product 2851A, Bio Quip, Inc., Compton, California, now defunct), consisting of a 12 W ultraviolet light mercury vapor bulb that attracts flying insects to three intercepting vanes, held over a funnel and a 19-L collecting bucket. The second was the MegaCatch ULTRA Mosquito Trap (EnviroSafe Technologies International Ltd.) consisting of an encased chamber emitting white light from a mercury vapor lamp or ultraviolet light from oscillating LEDs, 1-octen-3-ol from a slow-release lure, and CO2 from a pressurized cannister, and fitted with a suction fan and collecting basket. Despite concerted attempts over multiple nights in different areas, no kissing bugs were captured in either trap. Similarly, Kjos et al. (2013) caught no kissing bugs in eight Universal Mercury Vapor Black Light Traps deployed in Texas residential sites for 2-3 nights, while 153 specimens were collected manually during active searching.

In the absence of an efficacious stand-alone unattended trap to be used as a surveillance tool for flying kissing bugs, other more labor-intensive surveillance methods are traditionally used to evaluate kissing bug populations. For example, in a Texas study, a mean of 2.4 kissing bugs per hour of effort were collected by humans searching around a lighted building at night, daytime searching in nests of wood rats and dens of other small mammals, searching dog kennels during day or night, and removal of bugs from upright white sheets baited with ultraviolet light or ultraviolet light plus dry ice (Curtis-Robles et al. 2018). Similarly, Klotz et al. (2014) manually collected 134 kissing bugs around ultraviolet lights over two months in Arizona, and in an Argentinian study villagers harvested 16 adult kissing bugs from white sheets baited with ultraviolet light over 64 trap-nights, an average of 0.25 bugs per trap-night (Vazquez-Prokopec et al. 2004). Given the challenge of collecting kissing bugs, scent-detection dogs have been used in Paraguay (Rolon et al. 2011) and Texas (Christopher et al. 2023).

### BRIEF SUMMARY

In a first aspect, kissing bugs (Hemiptera: Reduviidae) were captured at night in an experimental trap comprising an upright tarpaulin barrier, a fluorescent light attached to a source of AC electricity, and a funnel leading to a collection receptacle containing propylene glycol as a preservative.

In a second aspect, surprising improvements on the performance and cost of catching kissing bugs were achieved by employing a multiple-funnel trap and an LED light source powered by a solar panel attached to a lithium battery and an associated timer that switched the light source on during the night. This novel composition was unexpectedly far superior to a cross-vane trap in number of kissing bugs captured, number of kissing bugs captured per trap-day, and number of kissing bugs per 1,000 other arthropods captured. The novel composition was also superior to the upright barrier trap described in the first aspect in number of kissing bugs captured per trap-day, and comparable by the other two criteria.

In a third aspect, multiple-funnel traps fitted with large or small LED lights were tested against multiple-funnel traps with no light source. Traps with large LED lights were superior to multiple-funnel traps in the other two treatments, showing that light intensity is critical in maximizing trap catch. Because traps with no light source captured only one kissing bug, it was concluded that multiple-funnel traps themselves are not effective in catching kissing bugs, and that effective performance in catching kissing bugs only occurs when multiple-funnel traps are combined with a suitable light source.

In a fourth aspect, multiple-funnel traps fitted with four small inexpensive LED light sources pointing in four equally spaced directions were comparable in efficacy in catching kissing bugs as traps fitted with two expensive and large LED light sources pointing in opposite directions.

In a fifth aspect, the components of a cost-effective operational kissing bug trap assembly include seven key embodiments: a supporting structure such as a post, a metal angle bracket for attaching the trap assembly to the supporting structure, a solar panel, a photocell sensor, and switch adjusted to turn on battery power to LED lights at the onset of darkness and off at the onset of daylight. All of the above are attached to or mounted on a multiple-funnel trap.

In a sixth aspect, said cost-effective operational kissing bug trap assembly can be used in surveillance and/or reduction of populations of kissing bugs in the order Hemiptera, family Reduviidae, subfamily Triatominae.

### BRIEF DESCRIPTION OF THE DRAWINGS

FIG. 1 depicts the entire kissing bug trap assembly, in accordance with an embodiment of the invention.

FIG. 2 depicts details of the kissing bug trap assembly in a front orthographic view, in accordance with an embodiment of the invention.

### DETAILED DESCRIPTION

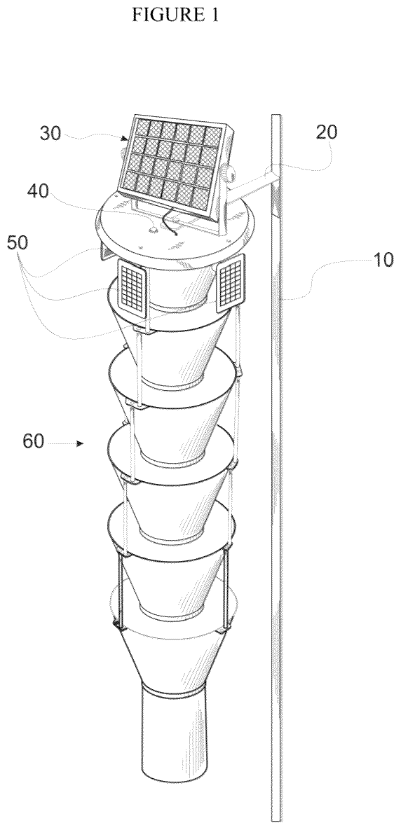

FIG. 1 depicts the entire kissing bug trap assembly, including supporting post (10), metal bracket for attaching the trap assembly to the supporting post (20), solar panel (30), photocell sensor (40), LED lights (50), and multiple-funnel trap per se (60).

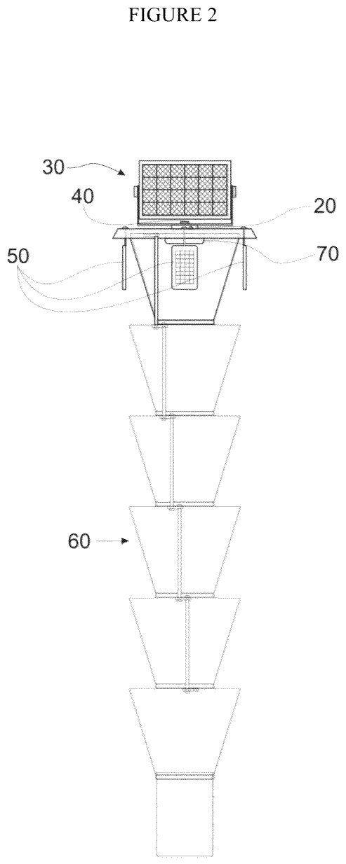

FIG. 2 depicts details of the kissing bug trap assembly in a front orthographic view, showing metal bracket for attaching the trap assembly to the supporting post (20), solar panel (30), photocell sensor (40), LED lights (50), multiple-funnel trap per se (60), and light controller unit with battery mounted below the lid for protection from rain (70).

Development and testing of prototype kissing bug traps progressed through a series of incremental steps, as outlined by five Examples.

### Example 1

Two prototype traps constructed and deployed in 2019 exploited the knowledge that kissing bugs respond at night to a photic stimulus and tentatively to traps presenting a large upright barrier (Sjogren and Ryckman 1966; Updyke and Allan 2018). The traps employed a vertical transparent tarpaulin (2×3 m) suspended with nylon rope attached to four upright 3-m-high metal fencing T-posts over a horizontally held tarpaulin funnel (2.4×2.4 m) tethered tightly with nylon rope to four upright 2.4-m-high T-posts and sloping inward to a central funnel aperture. This design created a large catchment surface to intercept approaching kissing bugs in flight, after which they would fall into the funnel. The tarpaulin funnel led to an aluminum funnel, which led into an elbow-curve tunnel, with small drain holes which allowed rain to flow out but allowed insects to pass through and to fall into a collection container containing propylene glycol, a non-toxic preservative that kills the insects and preserves nucleic acids for diagnostic analysis (Martoni et al. 2021).

Light units with extension cords connected to a source of AC power and a programmable timer (BN-LINK, Santa Fe Springs CA) were suspended directly above the vertical transparent tarpaulin with nylon rope from the four 3-m-high T-posts. One trap was equipped with a 20-W fluorescent black light and photo switch (BioQuip Products Inc., Compton, California, now defunct). The other trap was equipped with a two-socket light fixture holding two 120-W blue LED PAR38 flood lights (Epilux Commercial Lighting, Busan, Busan, Republic of Korea). These two lights were selected based on published information that kissing bugs are attracted to ultraviolet (UV) and blue wavelengths of light (Pacheco-Tucuch et al. 2012).

The fluorescent black light trap was deployed on private property in Mission, Texas, near the US-Mexico border and the blue LED flood light trap was deployed outside a research enclosure containing baboons in Bastrop, near Austin in central Texas. The south Texas unit was deployed from 8 April-28 Oct. 2019 and the central Texas unit was deployed from 13 June-24 October, both with weekly visits to collect all arthropods, replenish the propylene glycol, remove cobwebs and ensure that the light was working. Captured arthropods were stored in a refrigerator at 4.0° C. or transferred to 70% ethanol until the species of all kissing bugs could be identified (Lent and Wygodzinsky 1979).

The traps captured 130 kissing bugs (125 in the south Texas trap and five in the central Texas trap) representing three species, Triatoma gerstaeckeri, T. neotomae, and T. sanguisuga. This result suggests that if an operational trap for kissing bugs were to be developed, one of its main features should be a large vertical barrier to interrupt flight, and that another principal feature should be a bright light that is attractive to kissing bugs.

Despite the collection of a large number of bugs, over two hours of labor was required to erect one unit of this large prototype, and the materials showed poor durability when exposed to sun and wind. Moreover, a trap of this design is not suitable for mass production.

### Example 2

A search for commercial traps with a large vertical barrier disclosed a lack of such traps on the market for any insect in the order Hemiptera. The only available commercial traps that appeared to embrace such a feature were large cross-vane traps that were originally designed for catching wood-boring beetles (Coleoptera) and wood wasps (Hymenoptera) (McIntosh et al. 2001; Morewood et al. 2002), and which in one instance were used to catch kissing bugs in Texas (Pippin 1970) and Panama (Updyke and Allan 2018). Another commercially available product was the multiple-funnel trap, which was developed to catch very small ambrosia beetles and bark beetles that fly during daylight (Lindgren 1983, 1984). Multiple-funnel traps present a very narrow dark multifaceted silhouette that is very different from the large upright barrier embodied in traps previously shown to be effective for capturing kissing bugs (Sjogren and Ryckman 1966; Updyke and Allan 2018, Example 1).

Three types of traps were experimentally tested in the field in 2020.

The first trap type was a scaled-down version of the vertical barrier trap used in 2019. A vertical transparent tarpaulin (1.0×1.5 m) was suspended from four 3-m T-posts (embedded in the ground at an angle to create a teepee shape) over a black polystyrene plastic funnel (243.8×121.9×0.09 cm) below which was a 22.7-L bucket with the bottom 2 cm filled with propylene glycol. The bucket was held in place with three cinder blocks.

The second trap type was a commercial cross-vane trap (Synergy Semiochemicals Corp., Delta, BC, Canada) similar to the trap previously evaluated in Panama (Updyke and Allan 2018). The trap embodied four 20.3×61.0 cm upright vanes connected to a funnel leading to a collection cup with the bottom 4 cm filled with propylene glycol.

The third trap type was a six-unit multiple-funnel trap (Synergy Semiochemicals Corp., Delta, BC, Canada) with a collection cup filled to 4 cm with propylene glycol. Both the cross-vane and the multiple-funnel traps were suspended between two 2.4 m high upright metal T-posts.

Mounted at the top of each trap on a 45×25 cm rectangular 3.8 cm angle-iron frame attached to the support posts were two 40-unit 25-Watt LED lights emitting cool white light and pointed in opposite directions, and a 35.0×24.0 cm 6V/8 W solar panel connected to a 5-V 8000 mAh lithium-ion battery with a built-in photo-activated on-off switch (Shenzhen Lovefindahome Lighting & Furnishing Company Limited, Jiangmen, China), and said LED light, eliminating the need for an extension cord as used in 2019 and maintaining continuous light intensity all night.

One trap of each type was set up in a randomized order at least 15 m apart in at each of three locations: the same Mission, Texas study site as in 2019 (Mission-South), another site in Mission, Texas, where a citizen had collected kissing bugs (Mission-North), and at the Veterinary Medical Park in College Station, Texas. The Mission-South and Mission-North traps were deployed on 6 and 7 May, respectively, and left until 3 November. The College Station traps were deployed from 27 May-27 October. Captured arthropods were collected weekly and identified to species as above.

Of 91 kissing bugs captured, 67.0% were at the Mission South location. As in Example 1, three species were captured, Triatoma gerstaeckeri, T. neotomae, and T. sanguisuga. When the results for all three locations were pooled, the upright single panel trap captured the highest number of kissing bugs and the highest number of kissing bugs per 1,000 other (non-target) arthropods (Table 1). The multiple-funnel traps were surprisingly effective, capturing 2.7× more kissing bugs per trap-day than the cross-vane trap and approaching the performance of the upright single panel trap in total number of kissing bugs captured and number of kissing bugs per 1,000 other arthropods. The number of kissing bugs captured per trap-day would have been much higher if the experiment had been terminated at the end of September, when catches fell to almost zero in all traps.

TABLE 1
Comparative performance in 2020 in capturing kissing
bugs by three types of experimental traps. Results
pooled for traps deployed in three Texas locations.

| | Upright single | Cross-vane | Multiple-funnel |
|---|---|---|---|
| Criterion evaluated | panel trap | trap | trap |
| Number of operational | 412 | 513 | 513 |
| days (sum of three traps) | | | |
| Number of kissing bugs | 40 | 14 | 37 |
| captured | | | |
| Number of kissing bugs | 0.097 | 0.027 | 0.072 |
| per trap-day | | | |
| Number of other | 14,395 | 31,992 | 16,063 |
| arthropods captured | | | |
| Number of kissing bugs | 2.78 | 0.44 | 2.30 |
| per 1,000 other | | | |
| arthropods | | | |
| Cost (USD) of one trap | $211.30 | $138.32 | $136.89 |
| (all components) | | | |

Despite evidence that they can catch at least some kissing bugs (Updyle and Allan 2018), the cross-vane traps were eliminated from further consideration, because they exhibited the poorest performance, scoring well below the other two traps in all but the number of operational trap days. The number of kissing bugs per trap per day per cost of each unit was highest for the multiple-funnel trap, followed by the vertical panel trap, and then finally the cross-vane trap (Table 2). Because the cross-vane traps were by far the least discriminating in terms of species caught, considerable extra effort would be required to separate kissing bugs from non-target other arthropods. Further justification for removing the upright panel traps from further consideration was their high cost per trap, as well as poor durability and high maintenance requirements due to difficult set up, and a high level of wind damage.

TABLE 2
Summary of evaluation criteria for experimental vertical panel
traps and commercial cross-vane and multiple-funnel traps as
tools for capturing flying adult kissing bugs. Triatomines
per day per cost based on 2020 data with collections in Texas.

| | | | Triatomines |
|---|---|---|---|
| | | | per trap per |
| | | Set up and maintenance | day per cost |
| Trap type | Durability | requirements | *1000 |
| Vertical | Low | High: set up very labor- | 0.459 |
| single panel | | intensive, some traps | |
| trap | | destroyed in wind and | |
| | | not repairable | |
| Cross-vane | Medium | Medium: set up requires some | 0.195 |
| trap | | assembly, some wind damage | |
| | | to panels, but repairable | |
| Multiple-funnel | High | Low: set up easy, almost | 0.525 |
| trap | | no maintenance required | |

The performance of the multiple-funnel traps was remarkable because the funnel column presents a minimal upright barrier and does not permit the free-fall into a collecting funnel after hitting the trap that occurs when a kissing bug encounters the upright panel traps or the large upright vanes in the cross-vane traps. Based on the results in Table 1, only the multiple-funnel traps were considered worthy of further research.

### Example 3

An experiment in 2021 evaluated the importance of an attractive light stimulus and its intensity in combination with multiple-funnel traps. Three treatments were compared. The first was multiple-funnel traps with the same solar panel, battery and large LED light assembly as described in Example 2. The second was multiple-funnel traps as above with two small 40-unit LED lights (6,000 K temperature) connected to a 17.8×15.2 cm solar panel and a 3.2 V 4,500 mAh battery (Shenzhen EMANER Lighting Co. Ltd., Shenzhen, China). The third treatment was multiple-funnel traps as above with no light, solar panel, or battery. Four replicates were set up as randomized complete blocks, with the three traps spaced at least 15 m apart. One replicate was at the Mission-South site employed in Example 2 (20 April-2 December), and the other three were at three locations in Mexico, Jaboncillos (3 June-25 October), Maderes del Carmin (31 May-5 November), and Ciudad Victoria (28 May-4 November). Traps were serviced weekly, and the kissing bugs were identified to species as above.

One hundred four kissing bugs were captured in this experiment, representing three species, Triatoma gerstaeckeri, T. sanguisuga and Tratoma rubida. The latter species comprised 69 specimens from Jaboncillos and brought the total number of species captured in multiple-funnel traps to four, demonstrating their versatility for capturing different species of kissing bugs. The results showed that multiple-funnel traps with large LED lights were superior to multiple-funnel traps with small LED lights by two critical measures (Table 3). Traps with large LED lights captured 6.3× more kissing bugs per trap-day and 2.9× more kissing bugs per 1,000 other arthropods than traps with small LED lights. Thus, light intensity is an important feature to be incorporated into kissing bug traps. In addition, multiple-funnel traps with no light were unattractive, demonstrating that the presence of a light stimulus is necessary in combination with the vertical column of funnels.

TABLE 3
Comparative performance in 2021 in capturing kissing bugs
in multiple-funnel traps fitted with large or small LED
lights or no light. Results pooled for traps deployed
in one Texas location and three locations in Mexico.

| | Traps with two | Traps with two | |
|---|---|---|---|
| | large LED | small LED | Traps with |
| Criterion evaluated | lights | lights | no lights |
| Number of operational days | 672 | 672 | 672 |
| (sum of four traps) | | | |
| Number of kissing bugs | 89 | 14 | 1 |
| captured | | | |
| Number of kissing bugs per | 0.132 | 0.021 | 0.001 |
| trap-day | | | |
| Number of other arthropods | 23,595 | 10,855 | 1,897 |
| captured | | | |
| Number of kissing bugs per | 3.77 | 1.29 | 0.53 |
| 1,000 other arthropods | | | |

### Example 4

In 2022, the performance of multiple-funnel traps with different LED lights to attract kissing bugs was compared in Texas and Guatemala. In Texas the upright posts remained T-posts while in Guatemala they were replaced with rebar of the same length. One treatment was the same solar panel, battery and large LED light assembly as described in Example 2. The other was a small LED light assembly (Yomisga Solar Pendant Lights, Shenzhen Meize E-commerce Co., Ltd., Shenzhen, China) with four 128-LED lights each emitting 1,000 lumens with a 6000-65000K color temperature and pointing in four different directions at 90° intervals. The LED lights were powered by a 6.5V/3.5 W solar panel and an internal lithium polymer battery. For this assembly, the square mounting frame was replaced with a single cross-member on which both the solar panel and battery and the LEDs were mounted.

An experiment was run in Texas and Guatemala, with paired traps fitted with different LED light assemblies placed randomly at least 10 m apart. One paired trap replicate was set up in each of the Mission-South and Mission-North locations from 18 April-25 October, two replicates were set up at Lackland Airforce Base near San Antonio from 22 April-27, October 2022, and 4 replicates were set-up in Comapa, Guatemala from 7 Jul. 2022-21, May 2024. One of the traps with four small LED lights at Lackland Airforce Base had only four funnels and was deleted from the analysis.

One hundred sixty-nine Triatoma gerstaeckeri were captured in Texas (Table 3) and thirteen Triatoma dimidiata were captured in Guatemala. Traps with the large light with two LED panels captured 1.8× more kissing bugs than traps with the small light with four LED panels (Table 3). Considering the reduced cost of the small light, the number of kissing bugs per trap per day per cost was similar between the two units. This comparison doesn't include the additional advantage of the small lights being lighter, which would allow for one supporting stake instead of two and reduce shipping costs of a commercial unit.

TABLE 4
Comparative performance in 2022 in capturing kissing bugs in multiple-
funnel traps fitted with two large or four small LED lights. Results
pooled for four replicates in three Texas locations.

| | Traps with two | Traps with four |
|---|---|---|
| | large LED | small LED |
| Criterion evaluated | lights | lights |
| Number of operational days (sum of | 586 | 488 |
| four traps for traps with two | | |
| large LED lights and three traps | | |
| with four small LED lights) | | |
| Number of kissing bugs captured | 109 | 60 |
| Number of kissing bugs per trap-day | 0.186 | 0.123 |
| Number of other arthropods captured | 11,620 | 13,121 |
| Number of kissing bugs per 1,000 other | 9.38 | 4.57 |
| arthropods | | |
| Cost per unit ($42.89 for trap + | $116.89 | $81.89 |
| light + bracket) | | |
| Kissing bugs per trap per day per | 1.59 | 1.50 |
| cost * 1000 | | |

### Example 5

Because traps with four small LED lights weighed less than traps with two large LED lights, the number of supporting posts could be reduced from two to one. The entire trap assembly can then be hung from a metal angle bracket allowing versatile connection to metal or wooden posts.

The entire assembly is depicted in diagrammatic form in FIG. 1. The assembly comprises a supporting post (10), a metal bracket for attaching the trap assembly to the supporting post (20), a solar panel (30), and a photocell sensor and switch (40) adjusted to turn on battery power to LED lights (50) at the onset of darkness and off at the onset of daylight, all of which are attached to or mounted on a multiple-funnel trap (60). Further details of the kissing bug trap assembly are depicted in front orthographic view in FIG. 2, showing the metal bracket for attaching the trap assembly to the supporting post (20), the solar panel (30) mounted above the metal bracket and the trap lid, the photocell sensor and switch (40), LED lights (50), the multiple-funnel trap (60), and a light controller unit with battery (70) connected to the solar panel, the photocell sensor and switch and the LED lights are mounted below the lid for protection from rain. Modifications for hanging the trap instead of the metal bracket (20) include employing a supporting post curved to a right angle at its upper end from which the trap would be hung and hanging the trap from a member spanning the upper ends of two posts.

Because the kissing bug trap assembly as described, or with modifications that improve performance and/or lower cost without altering the basic structure or function of the assembly, is highly effective at capturing kissing bugs of multiple species, it is suitable for application in surveillance and/or reduction of kissing bug populations.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

It will be appreciated that the scope of the present invention is not limited to the above-described embodiments, but rather is defined by the appended claims, and these claims will encompass modifications of and improvements to what has been described.

The foregoing examples should be viewed as demonstrations of potential embodiments and are not exhaustive or necessarily conclusive as to the effectiveness of the present invention. In many situations, it may be preferable to utilize mixtures and conditions different from the above or use an embodiment of the invention which an example may have indicated was less effective but may be more optimal in such situation.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Many changes, modifications, variations and other uses and applications of the present construction will, however, become apparent to those skilled in the art after considering the specification and the accompanying figures. All such changes, modifications, variations and other uses and applications which do not depart from the spirit and scope of the invention are deemed to be covered by the invention which is limited only by the claims which follow.

It should be understood that while certain preferred forms, embodiments, and examples of this invention have been illustrated and described, the present invention is not to be limited to the specific forms or arrangement of parts described and shown, and that the various features described may be combined in other ways than those specifically described without departing from the scope of the present invention.

### REFERENCES CITED

### U.S. Patent Documents

Lindgren, B. S. 1984. Insect Trap. U.S. Pat. No. 4,471,563.

### Other Publications

Acree, F. Jr., R. B. Turner, H. K. Gouck, M. Beroza and N. Smith. 1968. L-Lactic acid: a mosquito attractant isolated from humans. Science 161:1346-1347.
Bentley, M. D., I. N. McDaniel, M. Yatagai, H.-P. Lee and R. Maynard. 1979. p-Cresol: an oviposition attractant of Aedes triseriatus. Environmental Entomology 8:206-209.
Bohman, B., A. M. Weinstein, C. R. Unelius, and M. G. Lorenzo. 2018. Attraction of Rhodnius prolixus males to a synthetic female-pheromone blend. Parasites & Vectors 11:418. https:://doi.org/10.1186/s13071-018-2997-z.
Braks, M. A. H., J. Meijerink and W. Takken. 2001. The response of the malaria mosquito, Anopheles gambiae, to two components of human sweat, ammonia and L-lactic acid, in an olfactometer. Physiological Entomology 26:142-148.
Castro, M. C., T. V. Barrett, W. S. Santos, F. Abad-Franch, and J. A. Rafael. 2010. Attraction of Chagas disease vectors (Triatominae) to artificial light sources in the canopy of primary Amazon rainforest. Memorias do Instituto Oswaldo Cruz 105:1061-1064.
Cruz-Lopez, L., E. A. Malo, J. C. Rojas, and E. D. Morgan. 2001. Chemical ecology of triatomine bugs: vectors of Chagas disease. Medical and Veterinary Entomology 15:351-357.
Christopher, D. M., R. Curtis-Robles, G. L. Hamer, J. Bejcek, A. B. Saunders, W. D. Roachell, T. L. Cropper, and S. A. Hamer. 2023. Collection of triatomines from sylvatic habitats by a Trypanosoma cruzi-infected scent-detection dog in Texas, USA. PLOS Negl Trop Dis 17(3): e0010813.
Curtis-Robles, R., E. J. Wozniak, L. D. Auckland, G. L. Hamer, and S. A. Hamer. 2015. Combining public health education and disease ecology research: Using citizen science to assess Chagas disease entomological risk in Texas. Plos Neglected Tropical Diseases 9: e0004235.
Curtis-Robles, R., I. B. Zecca, V. Roman-Cruz, E. S. Carbajal, L. D. Auckland, I. Flores, A. V. Millard, and S. A. Hamer. 2017. Trypanosoma cruzi (agent of Chagas disease) in sympatric human and dog populations in “Colonias” of the Lower Rio Grande Valley of Texas. American Journal of Tropical Medicine and Hygiene. 94:805-814.
De Lana, M. and E. M. de Menezes Machado. 2017. Biolofy of Trypanosoma cruzi and biological diversity. Pp. 345-369. In Telleriia, J. and M. Tibayrenc (Eds.). American trypanosomiasis Chagas disease. One hundred years of research. 2nd ed. Elsevier, Cambridge, MA.
Falvo, M. L., A. N. L. Figueiras, and G. Manrique. 2016. Spatio-temporal analysis of the role of faecal depositions in aggregation behaviour of the triatomine Rhodnius prolixus. Physiological Entomology 41:24-30.
Galvão, C. 2021. Taxonomy. Pp. 15-38. A. Guarneri and M. Lorenzo (eds.). Triatominae—The Biology of Chagas Disease Vectors. Springer International Publishing, Cham, Switzerland.
Hodo, C. L., and S. A. Hamer. 2017. Toward an ecological framework for assessing reservoirs of vector-borne pathogens: Wildlife reservoirs of Trypanosoma cruzi across the Southern United States. Institute for Laboratory Animal Research Journal 58:379-392.
Hoel, D. F., D. L. Kline and S. A. Allan. 2009. Evaluation of six mosquito traps for collection of Aedes albopictus and associated mosquito species in a suburban setting in north central Florida. Journal of the American Mosquito Control Association 25:47-57.
Indacochea, A., C. C. Gard, I. A. Hansen, J. Pierce, and A. Romero. 2017. Short-range responses of the kissing bug Triatoma rubida (Hemiptera: Reduviidae) to carbon dioxide, moisture, and artificial light. Insects 8. doi: 10.3390/insects8030090.
Irish, S. R., F. Chandre and R. N'Guessan. 2008. Comparison of Octenol- and BG Lure®-baited Biogents Sentinel Traps and an encephalitis virus surveillance trap in Portland, OR. Journal of the American Mosquito Control Association 24:393-397.
Kjos, A., P. L. Marcet, M. J. Yabsley, U. Kitron, K. F. Snowden, K. S. Logan, J. C. Barnes and E. M. Dotson. 2013. Identification of bloodmeal sources and Trypanosoma cruzi infection in triatomine bugs (Hemiptera: Reduviidae) from residential settings in Texas, the United States. Journal of Medical Entomology 50:1126-1139.
Klotz, S. A., J. O. Schmidt, P. L. Dorn, C. Ivanyi, K. R. Sullivan and L. Stevens. 2014. Free-roaming kissing bugs, vectors of Chagas disease, feed often on humans in the Southwest. American Journal of Medicine 127:421-426.
Knols, B. G. J., J. J. A. van Loon, A. Cork, R. D. Robinson, W. Adam, J. Meijerink, R. de Jong and W. Takken. 1997a. Behavioural and electrophysiological responses of the female malaria mosquito Anopheles gambiae (Diptera: Culicidae) to Limburger cheese volatiles. Bulletin of Entomological Research 87:151-159.
Knols, B. G. J., W. Takken, A. Cork and R. de Jong. 1997b. Odour-mediated, host-seeking behaviour of Anopheles mosquitoes: a new approach. Annals of Tropical Medicine and Parasitology 91 (Supplement 1): S117-S118.
Lazzari, C. R., M. H. Pereira, and M. G. Lorenzo. 2013. Behavioural biology of Chagas disease vectors. Memorias do Instituto Oswaldo Cruz 108:34-47.
Lee, B. Y., K. M. Bacon, M. E. Bottazzi, and P. J. Hotez. 2013. Global economic burden of Chagas disease: a computational simulation model. Lancet Infectious Disease 13:342-348.
Lent, H., and P. W. Wygodzinsky. 1979. Revision of the Triatominae (Hemiptera, Reduviidae), and their significance as vectors of Chagas' disease. Bulletin of the American Museum of Natural History 163:123-520.
Lindgren, B. S. 1983. A multiple funnel trap for scolytid beetles. Canadian Entomologist 115:299-302.
Maciel-de-Freitas, R., A. E. Eiras and R. Lourenço-de-Oliveira. 2006. Field evaluation of effectiveness of the BGSentinel, a new trap for capturing adult Aedes aegypti (Diptera: Culicidae). Memórias do Instituto Oswaldo Cruz 101:321-325.
Mackay, A., M. Amador and R. Barrera. 2013. An improved autocidal gravid ovitrap for the control and surveillance of Aedes aegypti. Parasites and Vectors 6:225.
Martoni, F., E. Nogarotto, A. M. Piper, R. Mann, I. Valenzuela, L. Eow, L. Rako, B. C. Rodoni and M. J. Blacket. 2021. Propylene glycol and non-destructive DNA extractions enable preservation and isolation of insect and hosted bacterial DNA. Agriculture 11:77.
Mathew, N., E. Ayyanar, S. Shanmugavelu and K. Muthuswamy. 2013. Mosquito attractant blends to trap host seeking Aedes aegypti. Parasitology Research 112:1305-1312.
McIntosh, R. L., P. J. Katinic, J. D. Allison, J. H. Borden and D. L. Downey, 2001. Comparative efficacy of five types of traps for woodborers in the Cerambycidae, Buprestidae and Siricidae. Agricultural and Forest Entomology 3:113-120.
McPhatter, L., W. Roachell, F. Mahmood, L. Hoffman, N. Lockwood, A. Osuna, J. Lopez, and M. Debboun. 2012. Vector surveillance to determine species composition and occurrence of Trypanosoma cruzi at three military installations in San Antonio, Texas. U.S. Army Medical Department journal, July-September: 12-21.
Minoli, S., F. Palottini, and G. Manrique. 2013. The main component of an alarm pheromone of kissing bugs plays multiple roles in the cognitive modulation of the escape response. Frontiers in Behavioral Neuroscience 7:77): 1-10. doi: 10.3389/fnbeh.2013.00077.
Morewood, W. D., K. E. Hein, P. J. Katinic and J. H. Borden. 2002. An improved trap for large woodboring insects, with special reference to Monochamus scutellatus (Coleoptera: Cerambycidae). Canadian Journal of Forest Research 32:519-525.
Mukabana, W. R., C. K. Mweresa, B. Otieno, P. Omusula, R. C. Smallegange, J. J. A. van Loon and W. Takken. 2012a. A novel synthetic odorant blend for trapping of malaria and other African mosquito species. Journal of Chemical Ecology 38:235-244.
Mweresa, C. K., P. Omusula, B. Otieno, J. J. A. van Loon, W. Takken and W. R. Mukabana. 2014. Molasses as a source of carbon dioxide for the malaria mosquitoes Anopheles gambiae and Anopheles funestus. Malaria Journal 13:160.
Nyasembe, V. O. and B. Torto. 2014. Volatile phytochemicals as mosquito semiochemicals. Phytochemistry Letters 8:196-201.
Oli, K., J. Jeffrey and I. Vythilingam. 2005. A comparative study of adult mosquito trapping using dry ice and yeast generated carbon dioxide. Tropical Biomedicine 22:249-251.
Pacheco-Tucuch, F. S., M. J. Ramirez-Sierra, S. Gourbiere, and E. Dumonteil. 2012. Public street lights increase house infestation by the Chagas disease vector Triatoma dimidiata. Plos One 7: e36207.
Pippin, W. F. 1970. The biology and vector capability of Triatoma Sanguisuga Texana Usinger and Triatoma gerstaeckeri (StÅL) compared with Rhodnius prolixus (StÅL) (Hemiptera: Triatominae) 1. Journal of Medical Entomology 7:30-45.
Rolón M., M. C. Vega, F. Román, A. Gómez, and A. R. de Arias. 2011. First report of colonies of sylvatic Triatoma infestans (Hemiptera: Reduviidae) in the Paraguayan Chaco, using a trained dog. PLOS Negl Trop Dis 5: e1026.
Schmaedick, M. A., T. S. Ball, T. R. Burkot and N. E. Gurr. 2008. Evaluation of three traps for sampling Aedes polynesiensis and three other mosquito species in American Samoa. Journal of the American Mosquito Control Association 24:319-322.
Sjogren, R. D., and R. E. Ryckman. 1966. Epizootiology of Trypanosoma cruzi in southwestern North America. 8. Nocturnal flights of Triatoma protracta (Uhler) as indicated by collections at black light traps (Hemiptera: Reduviidae: Triatominae). Journal of Medical Entomology 3:81-92.
Takken, W. and D. L. Kline. 1989. Carbon dioxide and 1-octen-3-ol as mosquito attractants. Journal of the American Mosquito Control Association 5:311-316.
Updyke, E. A., and B. F. Allan. 2018. An experimental evaluation of cross-vane panel traps for the collection of sylvatic triatomines (Hemiptera: Reduviidae). Journal of Medical Entomology 55:485-489.
Vazquez-Prokopec, G. M., M. C. Cecere, D. M. Canale, R. E. Gurtler, and U. Kitron. 2005. Spatiotemporal patterns of reinfestation by Triatoma guasayana (Hemiptera: Reduviidae) in a rural community of northwestern Argentina. Journal of Medical Entomology 42:571-581.
von Oppen, S., H. M. Masuh, S. Licato, E. Zerba and P. Gonzalez-Audino. 2015. A floral-derived attractant for Aedes aegypti mosquitoes. Entomologia Experimentalis et Applicata 155:184-192.

What is claimed is:

1. A composition for trapping flying adult kissing bugs, comprising seven embodiments: a multiple-funnel trap comprised of at least one funnel; a light source; a solar panel; a battery; a photocell sensor and switch; a supporting structure; and an angle bracket.

2. The composition of claim 1, wherein the multiple-funnel trap can have up to 16 funnels.

3. The composition of claim 1, wherein the collecting cup of said multiple-funnel trap contains a non-toxic preservative.

4. The composition of claim 3, wherein the preservative can be propylene glycol.

5. The composition of claim 1, wherein the light source can be one or more light emitting diodes.

6. The composition of claim 5, wherein the light emitting diode or diodes can emit electromagnetic radiation selected from wavelengths ranging from 100 nm to 1 mm.

7. The composition of claim 1, wherein the solar panel is capable of generating enough electricity to power said light emitting diode or diodes for an entire night.

8. The composition of claim 1, wherein the battery is a lithium battery.

9. The composition of claim 1, wherein the photocell sensor and switch can turn on said light emitting diode or diodes at the onset of darkness and turn off said light emitting diode or diodes at the onset of daylight.

10. The composition of claim 1, wherein the supporting structure can be made of wood.

11. The composition of claim 1, wherein the supporting structure can be made of metal.

12. The composition of claim 1, wherein the angle bracket is affixed to the supporting structure.

13. The composition of claim 14, wherein said multiple-funnel trap is suspended from said angle bracket.

14. The composition of claim 1, wherein the captured kissing bugs are in the Order Hemiptera, Family Reduviidae, Subfamily Triatominae.

15. A method of capturing flying adult kissing bugs, employing a composition comprised of seven embodiments, including: multiple-funnel trap; a light source; a solar panel; a battery; a photocell sensor and switch; a supporting structure; an angle bracket.

16. The method of claim 15, wherein the collecting cup of the multiple-funnel trap contains propylene glycol as a preservative.

17. The method of claim 16, wherein the light source is automatically turned on at the onset of darkness and off at the onset of daylight, enabling capture of night-flying adult kissing bugs.

18. The method of claim 15, wherein the captured kissing bugs are in the Order Hemiptera, Family Reduviidae, Subfamily Triatominae.

19. The method of claim 17, wherein enumeration and speciation of captured flying adult kissing bugs can be used in surveillance of the occurrence, distribution, and numbers of kissing bug populations of a target species.

20. The method of claim 17, wherein flying adult kissing bugs can be captured in sufficient numbers that a local population of kissing bugs of a target species is lowered to a level that reduces the risk of humans and animals contracting Chagas disease.
